(19) United States
(12) Patent Application Publication
(10) Pub. No.: US 2026/0121512 A1
(43) Pub. Date: Apr. 30, 2026

(54) Self-Powered Gate-Driving Circuit for Cascode Power Device

(71) Applicant: The Hong Kong University of Science and Technology, Hong Kong (CN)

(72) Inventors: Ji SHU, Hong Kong (CN); Jing CHEN, Hong Kong (CN)

(21) Appl. No.: 19/350,155

(22) Filed: Oct. 6, 2025

Related U.S. Application Data
(60) Provisional application No. 63/711,716, filed on Oct. 25, 2024.

(51) Int. Cl. H02M 1/08; H02M 1/00

(52) U.S. Cl. CPC H02M 1/08; H02M 1/0006

(57) ABSTRACT

A gate-driving circuit for controlling a cascode power device to switch on or off while suppressing ground bounce has a gate-driving signal generator and a local power supply. The gate-driving signal generator, which receives an external control signal and accordingly generates a gate-driving signal to drive a gate of the cascode power device, is entirely powered by the local power supply. The local power supply is powered with raw electrical power received from an M point of the cascode power device such that the gate-driving circuit is self-powered without connecting to an external power supply. It avoids a need to install an isolation circuit for ground isolation between the external power supply and the cascode power device for suppressing ground bounce. Advantageously, elimination of the external power supply and isolation circuit leads to a simplified and more-compact design of the gate-driving circuit.

### CROSS-REFERENCE TO RELATED APPLICATIONS

This application claims priority to, and the benefit of, U.S. Provisional Patent Application Ser. No. 63/711,716 filed Oct. 25, 2024, the disclosure of which is incorporated by reference herein in its entirety.

### ABBREVIATIONS

BTU bootstrap unit
DC direct-current
DGND digital ground
DUT device under test
GaN gallium nitride
GND ground
HEMT high-electron-mobility transistor
IC integrated circuit
JFET junction field-effect transistor
KS Kelvin source
MOSFET metal-oxide-semiconductor field-effect transistor
SiC silicon carbide
VTH threshold voltage
WBG wide-bandgap

### TECHNICAL FIELD

The present disclosure generally relates to a gate-driving circuit used for driving a gate of a semiconductor power device. In particular, the present disclosure relates to such gate-driving circuit that is self-powered without connecting to an external power supply to thereby simplify the gate-driving circuit design.

### BACKGROUND

Power devices based on WBG semiconductors, such as GaN and SiC, are suitable for the next-generation high-efficiency and high-power-density converters, mainly owing to their superior properties over the Si-based counterparts, such as higher operation temperature, faster switching speed, and lower specific on-resistance.

The co-packaged all-WBG GaN/SiC cascode device combines highly desired characteristics in a power device simultaneously, including normally-off operation, high channel mobility, high current handling capability, high-voltage blocking with avalanche capability, fast switching speed, thermally stable V_{TH}, reverse-recovery-free reverse conduction, and strong dv/dt control, emerging as an ideal high-voltage power device for high-frequency high-efficiency power conversion systems [1], [2].

Every power device requires a gate driver IC and a peripheral power supply system to generate gate-driving signals. For fast-switching WBG power devices with much higher switching dv/dt and di/dt, the gate driving system design is more challenging. During the fast-switching transient, parasitic inductances, especially the common-source inductance, induce significant voltage pulses that not only impede the switching speed but also couple noise from the power loop into the gate loop, leading to switching oscillations and false triggering issues.

The KS connection is the most effective way to minimize common-source inductance, as recommended and provided by most commercially-available WBG power devices. However, the KS connection results in a floating reference ground node for the gate driver IC. During the fast-switching transient, the high di/dt can induce significant voltage pulses (several tens of volts) on the parasitic inductance between the reference digital DGND of the driver IC (i.e. the KS) and the earth GND of the power device driven by it. The induced voltage pulses inject noise into the gate-driving circuit, shifting the reference digital ground potential of the gate driver IC (also known as the ground bounce). The ground bounce effect results in unintended switching, oscillation, switching performance degradation, and even system failure.

In [3] and [4], isolated gate-driving circuits with reference to the KS node are used to suppress the ground bounce effect for both high-side and low-side devices. However, the isolated gate drivers require external isolated power supplies, especially the isolated DC/DC power supply modules, introducing significant complexity and cost.

There is a need in the art for a simplified gate-driving circuit that suppresses the ground bounce effect without a need for installing any isolated DC/DC power supply module.

### SUMMARY

The present disclosure provides a gate-driving circuit for controlling a cascode power device to switch on or off according to an external control signal via driving a gate of the cascode power device with a gate-driving voltage.

The gate-driving circuit comprises a gate-driving signal generator and a local power supply. The gate-driving signal generator is configured to receive the external control signal and generate the gate-driving signal according to the external control signal as received. The gate-driving signal generator is further configured to be entirely powered by a single power source. The local power supply acts as the single power source for powering the gate-driving signal generator. The local power supply is further configured to be powered with raw electrical power received from an M point of the cascode power device such that the gate-driving circuit is self-powered without connecting to an external power supply. As a result, it avoids a need to install an isolation circuit to isolate a ground of the external power supply and an earth ground of the cascode power device for suppressing ground bounce.

In certain embodiments, the gate-driving signal generator comprises a gate driver IC and a digital isolator IC. The gate driver IC is used for generating the gate-driving signal according to a first control signal. The gate-driving signal and first control signal are referenced to a DGND of the gate driver IC. The digital isolator IC is configured to receive the external control signal and generate the first control signal according to the external control signal such that the first control signal and external control signal are mutually electrically-isolated to achieve ground isolation.

In certain embodiments, the gate-driving signal generator comprises a gate driver IC with a digital isolator IC. The gate driver is configured to generate the gate-driving signal from the external control signal. In one option, the gate-driving signal and external control signal are referenced to a DGND of the gate driver IC. In another option, the gate driver is further configured to receive and process the external control signal, where the external control signal has a signal format of a differential input signal.

In certain embodiments, the local power supply comprises a BTU and a voltage regulator. The BTU is configured to receive the raw electrical power from the M point of the cascode power device and to generate an unregulated supply voltage from the raw electrical power. The voltage regulator is used for generating a regulated supply voltage from the unregulated power supply voltage, where the regulated supply voltage is used to power the gate-driving signal generator.

In certain embodiments, the voltage regulator is a LDO regulator.

In certain embodiments, the voltage regular is selected from a switch capacitor converter, a buck converter, a boost converter, a buck-boost converter, and combinations thereof.

In certain embodiments, the BTU includes a diode and one or more capacitors. The one or more capacitors are used for storing electrical energy received from the M point of the cascode power device such that the electrical energy is releasable from the one or more capacitors to power the gate-driving signal generator. The diode is used for blocking the electrical energy stored in the one or more capacitors from flowing back to the M point of the cascode power device.

The diode may be a Schottky barrier diode, a pn junction diode, or a lateral field-effect rectifier.

The gate driver IC may be configured to generate the gate-driving signal that is adapted to drive a gate of a particular type of cascode power device. The particular type of cascode power device may be a GaN/SiC cascode device, a Si/SiC cascode device, or a Si/GaN cascode device.

Other aspects of the present disclosure are disclosed as illustrated by the embodiments hereinafter.

### BRIEF DESCRIPTION OF THE DRAWINGS

FIG. 1 depicts a schematic diagram of a conventional gate-driving circuit.

FIG. 2 depicts a first schematic diagram of a self-powered gate-driving circuit as disclosed herein in accordance with one aspect of the present disclosure.

FIG. 3 depicts a second schematic diagram of the disclosed self-powered gate-driving circuit in accordance with another aspect of the present disclosure.

FIG. 4 illustrates an operation principle of the disclosed self-powered gate-driving circuit.

FIG. 5 depicts a test circuit used to characterize a switching process of a GaN/SiC cascode device when respectively equipped with the disclosed self-powered gate-driving circuit and with a conventional externally-powered gate-driving circuit.

FIG. 6 shows photos of test boards when respectively equipped with the conventional externally-powered gate driver and with the disclosed self-powered gate-driving circuit.

FIG. 7 plots switching waveforms of the GaN/SiC cascode device when equipped with the disclosed self-powered gate-driving circuit.

FIG. 8 plots switching transient waveforms during a turn-on process of the cascode device when respectively equipped with the self-powered gate-driving circuit and with the conventional externally-powered gate-driving circuit.

FIG. 9 plots switching transient waveforms during a turn-off process of the cascode device when respectively equipped with the self-powered gate-driving circuit and with the conventional externally-powered gate-driving circuit.

FIG. 10 plots switching losses of the GaN/SiC cascode device at various current levels when respectively equipped with the self-powered gate-driving circuit and with the conventional externally-powered gate-driving circuit.

Skilled artisans will appreciate that elements in the figures are illustrated for simplicity and clarity and have not necessarily been depicted to scale.

### DETAILED DESCRIPTION

As used herein, “a cascode power device”, or “a cascode device” in short, is a semiconductor device formed by a high-voltage D-mode power device connected in a cascode manner with a low-voltage E-mode power device. Regarding the cascode connection, a source of the high-voltage D-mode power device is connected to a drain of the low-voltage E-mode power device. The connection point between the source of the high-voltage D-mode power device and the drain of the low-voltage E-mode power device is herein referred to as “an M point” or “an interconnection point” of the cascode power device. A gate of the high-voltage D-mode power device is connected to a source of the low-voltage E-mode power device for biasing.

Examples of the cascode power device include, but are not limited to, a GaN/SiC cascode device (viz., a GaN-HEMT/SiC-JFET cascode device), a Si/SiC cascode device (viz., a Si-MOSFET/SiC-JFET cascode device), a Si/GaN cascode device (viz., a Si-MOSFET/GaN-HEMT cascode device), etc. In the GaN/SiC cascode device, a normally-on SiC JFET and a normally-off GaN HEMT are used as the high-voltage D-mode power device and the low-voltage E-mode power device of the cascode power device, respectively. There are similar arrangements for the Si/SiC and Si/GaN cascode devices.

As used herein, “a bootstrap unit” (abbreviated as BTU) is a bootstrap circuit, or a variant thereof, for providing a floating voltage supply, where the floating voltage supply is generated in the BTU from a raw electrical energy source. The bootstrap circuit is typically implemented with diode(s), capacitor(s) and resistor(s). A capacitor in the BTU may be used to store electrical energy received from the raw electrical energy source, and the stored electrical energy is releasable from the capacitor for setting up the floating voltage supply. A diode in the BTU may be used to block the electrical energy stored in the capacitor from flowing back to the raw electrical energy source.

As used herein, “a LDO regulator” is a voltage regulator IC designed to maintain a stable output voltage even when an input voltage is only slightly higher than a desired output voltage.

As used herein, “an isolated DC/DC converter” is an electrical/electronic circuit used to convert voltages among different parts of a system having different ground potentials.

As used herein, “a digital isolator” is a device that safely transfers digital signals between two circuits by providing galvanic isolation for preventing ground loops and high voltages from interfering with the signals. One example of the digital isolator is a high-speed optocoupler.

The present disclosure provides a self-powered gate-driving circuit for a cascode power device. The cascode power device may be, but is not limited to, a GaN/SiC cascode power device. The interconnection point (i.e. the M point) serves as an energy source for the gate-driving circuit, eliminating the requirement for an external power supply and one or more isolated DC/DC converter modules and hence reducing the associated cost, space, and complexity in manufacturing the gate-driving circuit. Most importantly, the GaN/SiC cascode device equipped with the self-powered gate-driving circuit delivers very comparable switching loss with a conventional isolated gate driver, benefiting a high-power-density power converter design with a high efficiency.

Before embodiments of the present disclosure are disclosed, an overview of advantages of the disclosed gate-driving circuit over prior-art gate drivers is first given. In a prior-art gate driver, an external power supply system is used to power up an isolated gate driver for both high-side and low-side power devices to suppress the effect of ground bounce on the operation of WBG power devices. The present disclosure suggests a new self-powered gate-driving circuit that can source power from the interconnection point, i.e. the M point, of the cascode power device. The new solution eliminates a need for an external power supply system, leading to a more compact design for increasing the power density of a power conversion system. Most importantly, the new design as disclosed herein does not increase the switching loss such that the efficiency of the power conversion system would be not compromised.

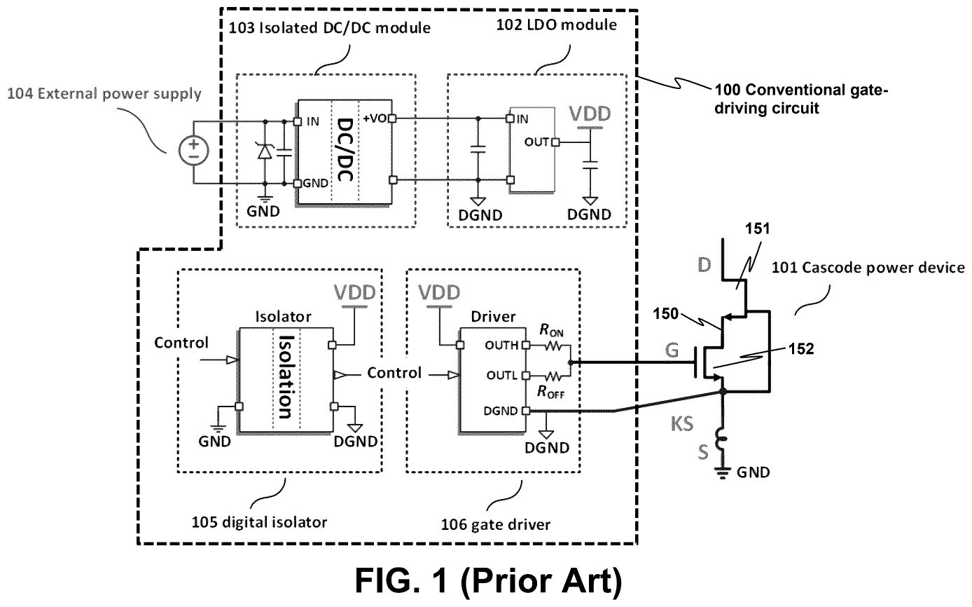

The present disclosure is elaborated as follows with the aid of FIGS. 1-10.

FIG. 1 depicts a cascode power device 101 driven by a conventional gate-driving circuit 100 with an external power supply 104 that sources power for the conventional gate-driving circuit 100. An isolated DC/DC module 103 and various other peripheral circuits provide a floating power supply that is stabilized via a LDO module 102 and is delivered to a digital isolator 105 and a gate-driver IC 106. Note that the cascode power device 101 is formed by connecting a high-voltage normally-on (i.e., D-mode) JFET 151 and a low-voltage normally-off (i.e., E-Mode) GaN HEMT 152. The point connecting the JFET 151 and the HEMT 142 is an M point 150.

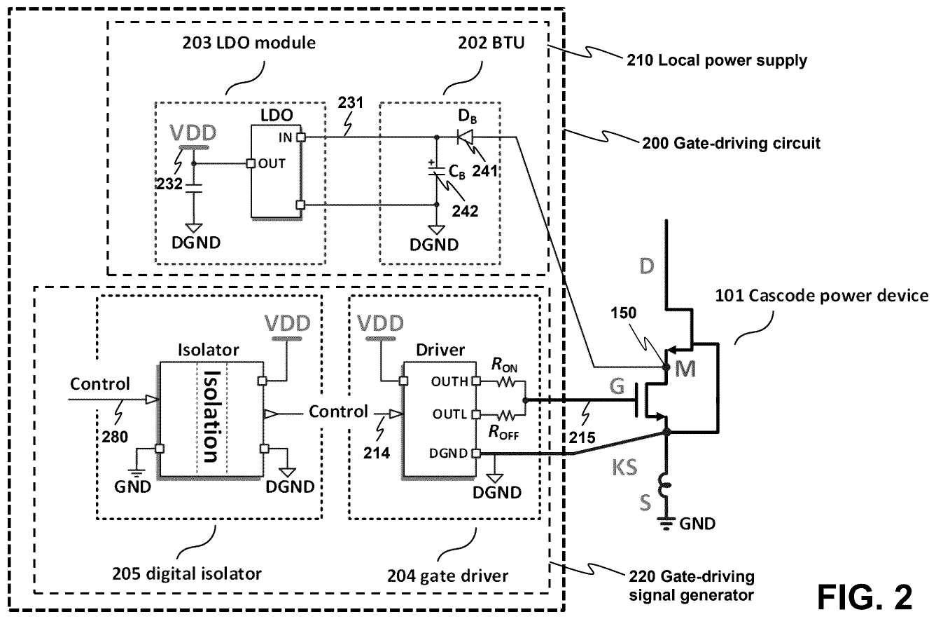

FIG. 2 depicts the cascode power device 101 driven by the disclosed self-powered gate-driving circuit 200 without an external power supply, an expensive and bulky isolated DC/DC module and various peripheral circuits. The gate-driving circuit 200 can source power from the interconnection point 150 (i.e., the M point 150) of the cascode device 101 via a BTU 202 and deliver a stable power supply VDD to a digital isolator IC 205 and a gate driver IC 204 via a LDO module 203. Note that apart from the LDO module 203, any one of other appropriate voltage regulators may be used to provide VDD. Since the LDO module 203 is referenced to the DGND of the gate-driving circuit 200, the generated VDD is also a local power supply voltage that is naturally isolated and floating. As a result, the ground bounce effect on the gate driver circuit 200 can be effectively suppressed.

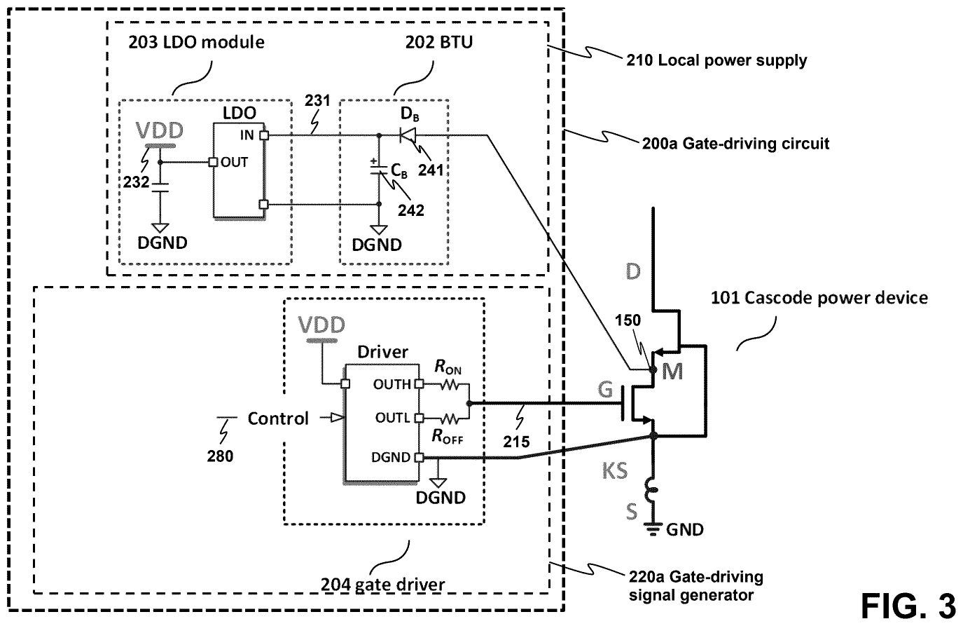

FIG. 3 depicts another realization of the disclosed self-powered gate-driving circuit 200a. The gate-driving circuit 200a can source power from the interconnection point 150 (i.e. the M point 150) of the cascode device 101 via the BTU 202 and deliver a stable power supply voltage VDD for the gate driver 204 via the LDO module 203. Since the LDO module 203 is referenced to the DGND of the gate-driving circuit 200a, the generated VDD is also a local power supply voltage that is naturally isolated and floating. As a result, the ground bounce effect can be effectively suppressed.

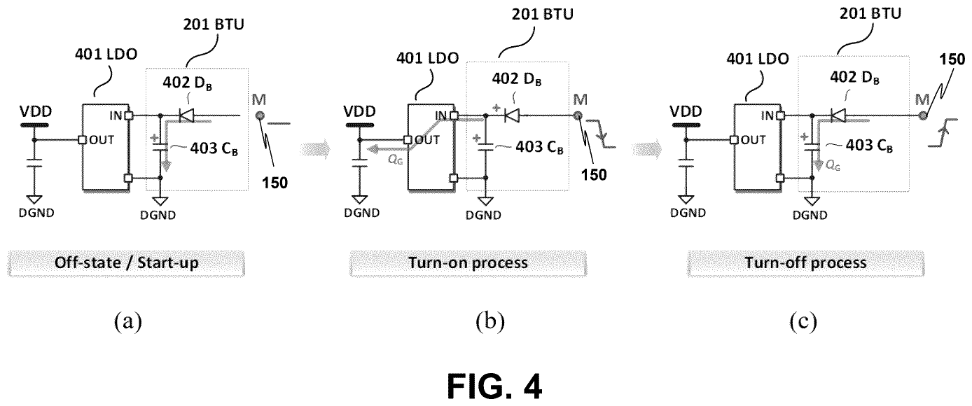

FIG. 4 shows the operation principle of the disclosed self-powered gate-driving circuit 200/200a. The most important part of the operation process is to source power from the M point 150 of the cascode device 101 and deliver a stable voltage VDD for the gate driver IC 204 and the digital isolator 105 (if any). During the start-up phase (subplot (a) of FIG. 4) and the off-state (subplot (c) of FIG. 4), the normally-on feature of the high-voltage device (i.e., the JFET 151) within the cascode power device 101 pulls up the potential of the M point 150, thereby the diode D_{B} 402 in the BTU 202 is turned on, allowing a current to flow and store charge into the capacitor C_{B} 403 of the BTU 202. As a result, the voltage of C_{B} 403 is elevated and the LDO module 401 is activated and delivering a stable voltage VDD for the gate driver IC and the digital isolator IC of the gate-driving circuit. During the turn-on phase (subplot (b) of FIG. 4), when the voltage of the M point 150 drops to the on-state voltage of the normally-off low-voltage device (i.e. the GaN HEMT 152) within the cascode power device 101 (e.g., 0.1 V), the diode D_{B} 402 enters the blocking mode, the charge is stored within the capacitor C_{B} 403 and keep delivering power for the gate-driving circuit 200/200a via the LDO module 401. During the turn-on process, the gate-driving circuit 200/200a consumes a few nC of charge, which is the gate charge Q_{G} of the cascode power device 101, stored within the capacitor C_{B} 403, leading to a slight voltage drop on the capacitor C_{B} 403. During the turn-off process, once the cascode device 101 is turned off and the voltage of the M point 150 is elevated over the voltage of capacitor C_{B} 403, the diode D_{B} 402 is turned on again, replenishing the consumed charge (i.e. Q_{G}) back into the capacitor C_{B} 403. Based on the operation principle of the self-powered gate-driving circuit 200/200a, the capacitance of capacitor C_{B} 403 within the BTU 202 should be higher than 100 nF to suppress the voltage fluctuation during the switching process.

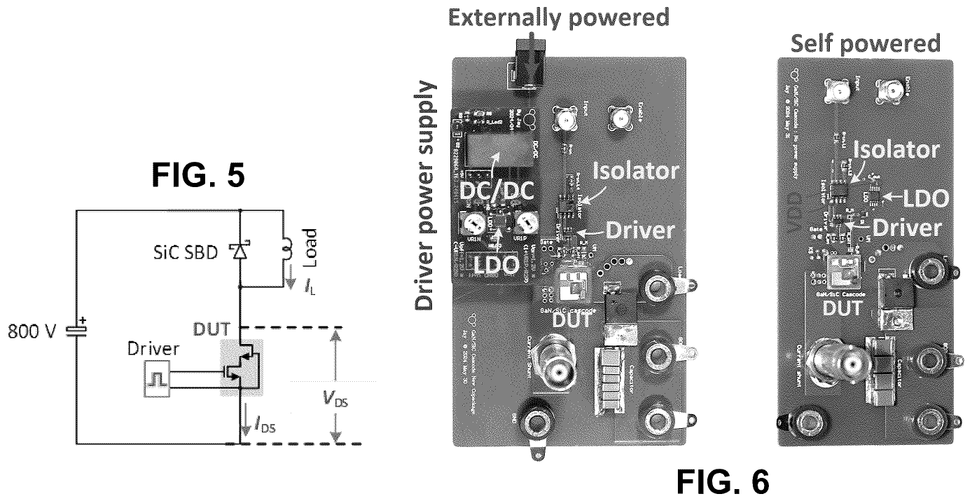

FIG. 5 depicts a test circuit used to characterize the switching process of the cascode power device 101 when equipped with the disclosed self-powered gate-driving circuit 200. The 1.2 kV GaN-HEMT/SiC-JFET cascode device is selected as the DUT. The drain-source voltage V_{DS} of the DUT, the drain-source current I_{DS} of the DUT, the M point voltage V_{M} of the DUT, and the current of the load inductor I_{L} are characterized.

FIG. 6 shows photos of test boards used to characterize the switching process of the cascode power device 101 when equipped with the conventional externally-powered gate-driving circuit 100 and the disclosed self-powered gate-driving circuit 200. Thanks to the elimination of the external power supply and the isolated DC/DC module, the test board when equipped with the self-powered gate-driving circuit 200 can be much simpler and more compact.

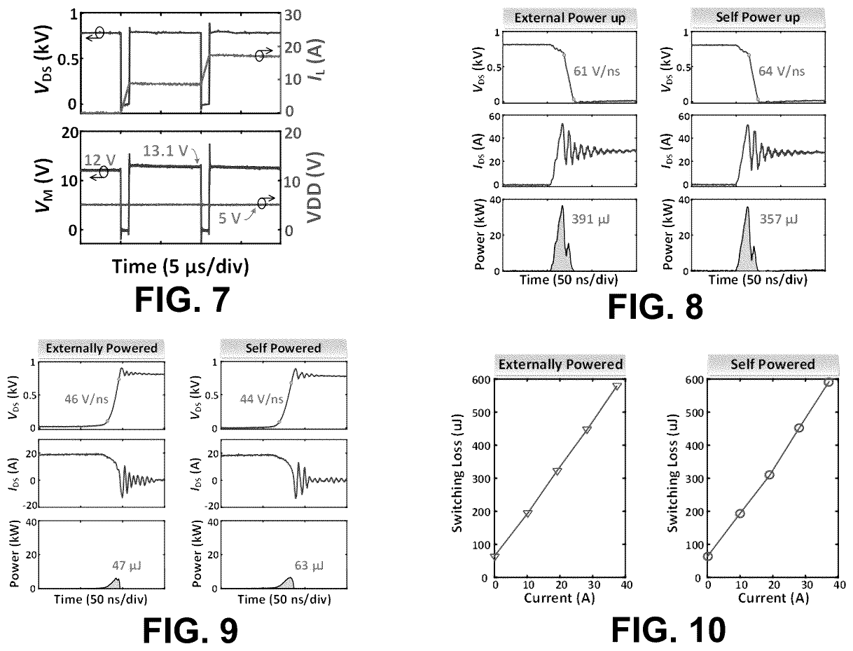

FIG. 7 plots switching waveforms of the GaN/SiC cascode device when equipped with the disclosed self-powered gate-driving circuit 200. It is apparent that when equipped with this circuit, the GaN/SiC cascode power device is successfully switched ON and OFF fully under control.

FIGS. 8 and 9 plot switching transient waveforms and loss of the GaN/SiC cascode device when equipped with the disclosed self-powered gate-driving circuit 200 during turn-on and turn-off processes, respectively. It is apparent that when equipped with this circuit, the GaN/SiC cascode power device exhibits comparable switching loss and switching speed with the conventional externally-powered gate-driving circuit 100.

FIG. 10 shows the overall switching loss of the GaN/SiC cascode device at various current levels. It is shown that when equipped with the disclosed self-powered gate-driving circuit 200, the GaN/SiC cascode device exhibits a comparable switching loss with the conventional gate-driving circuit 100 that uses the external power supply.

Embodiments of the present disclosure are developed as follows based on the details, examples, applications, etc. regarding the self-powered gate-driving circuit as disclosed above possibly with generalization and extension.

Refer to FIGS. 2 and 3. A main aspect of the present disclosure is to provide a gate-driving circuit 200/200a for controlling a cascode power device 101 to switch on or off according to an external control signal 280 via driving a gate of the cascode power device 101 with a gate-driving voltage 215.

Exemplarily, the gate-driving circuit 200/200a comprises a gate-driving signal generator 220/220a and a local power supply 210. The gate-driving signal generator 220/220a is configured to receive the external control signal 280 and generate the gate-driving signal 215 according to the external control signal 280 as received. The gate-driving signal generator 220/220a is further configured to be entirely powered by a single power source. The local power supply 210 acts as the single power source for powering the gate-driving signal generator 220/220a. The local power supply 210 is further configured to be powered with raw electrical power received from an M point 150 of the cascode power device 101 such that the gate-driving circuit 200/200a is self-powered without connecting to an external power supply. As used herein, “raw electrical power received from an M point” means electrical power directly received from the M point. As a result, it avoids a need to install an isolation circuit (e.g., the isolation DC/DC module 103 in the conventional gate-driving circuit 100) to isolate a ground of the external power supply and an earth ground of the cascode power device 101 for suppressing ground bounce. Advantageously, elimination of the external power supply and isolation circuit leads to a simplified and more-compact design of a gate-driving circuit for the cascode power device 101.

Refer to FIG. 2. In one group of certain embodiments, the gate-driving signal generator 200 comprises a gate driver 204 and a digital isolator 205. The gate driver 204 is used for generating the gate-driving signal 215 according to a first control signal 214. The gate-driving signal 215 and the first control signal 214 are both referenced to a DGND of the gate driver 204. The digital isolator 205 is configured to receive the external control signal 280 and generate the first control signal 214 according to the external control signal 280 such that the first control signal 214 and the external control signal 280 are mutually electrically-isolated to achieve ground isolation. Specifically, the external control signal 280 is referenced to the earth ground of the cascode power device 101 while the first control signal 214 is referenced to the DGND of the gate driver 204.

Refer to FIG. 3. In another group of certain embodiments, the gate-driving signal generator 200a comprises the gate driver 204 particularly configured to generate the gate-driving signal 215 from the external control signal 280. Note that the digital isolator 205 is not present in the gate-driving signal generator 200a. In one realization of the gate-driving signal generator 200a, the gate-driving signal 215 and the external control signal 280 are both referenced to a DGND of the gate driver 204, as a result that the digital isolator 205 is absent. In another realization of the gate-driving signal generator 200a for the specific case that the external control signal 280 is a differential input signal, the digital isolator 205 is also not needed since the differential input signal does not cause ground bounce. In this specific case, the gate-driving signal 215 is referenced to DGND of the gate driver 204. In addition, the gate driver 204 is further configured to receive and process the external control signal 280 that has a signal format of a differential input signal.

Other details of the gate-driving circuit 200/200a are elaborated as follows.

In implementation of the gate-driving circuit 200/200a, preferably, the local power supply 210 comprises a BTU 202 and a voltage regulator (also referenced as 203 for convenience). The BTU 202 is configured to receive the raw electrical power from the M point 150 of the cascode power device 101 and to generate an unregulated supply voltage 231 from the raw electrical power. The voltage regulator 203 is used for generating a regulated supply voltage 232 (VDD) from the unregulated power supply voltage 231. The regulated supply voltage 232 is used to power the gate-driving signal generator 220/220a.

The voltage regulator 203 may be a LDO regulator 203. Alternatively, the voltage regular 203 may be selected from a switch capacitor converter, a buck converter, a boost converter, a buck-boost converter, and combinations thereof.

Usually, the BTU 202 includes a diode 241, and one or more capacitors 242. The one or more capacitors 242 are for storing electrical energy received from the M point 150 of the cascode power device 101 such that the electrical energy is releasable from the one or more capacitors 242 to power the gate-driving signal generator 220/220a. Typically, the one or more capacitors 242 are connected in parallel to aggregate respective capacitances. The diode 241 is used for blocking the electrical energy stored in the one or more capacitors 242 from flowing back to the M point 150 of the cascode power device 101. As such, a voltage rating of the diode 241 is required to be higher than the maximum voltage of the M point 150 of the cascode power device 101. Furthermore, an additional resistor may be connected in series with the diode 214 for protecting the diode 214. In implementation, the diode 241 may be realized as a Schottky barrier diode, a pn junction diode, or a lateral field-effect rectifier. Also in implementation, the one or more capacitors 242 of the BTU 202 may also serve as input capacitor(s) of the LDO module 203.

As mentioned above, the cascode power device 101 may be a GaN/SiC cascode device, a Si/SiC cascode device, a Si/GaN cascode device, etc. In implementation of the gate-driving circuit 200/200a, the gate driver 204 may be configured to generate the gate-driving signal 215 that is adapted to drive a gate of a particular type of the cascode power device 101, such as a GaN/SiC cascode device, a Si/SiC cascode device and a Si/GaN cascode device.

The present disclosure may be embodied in other specific forms without departing 1from the spirit or essential characteristics thereof. The present embodiment is therefore to be considered in all respects as illustrative and not restrictive. The scope of the invention is indicated by the appended claims rather than by the foregoing description, and all changes that come within the meaning and range of equivalency of the claims are therefore intended to be embraced therein.

### REFERENCES

There follows a list of references that are occasionally cited in the specification. Each of the disclosures of these references is incorporated by reference herein in its entirety.
[1] J. Shu, J. Sun, Z. Zheng, and K. J. Chen, “Protecting SiC JFET from Gate Overstress in GaN/SiC Cascode Device without Compromising Switching Performance,” IEEE Transactions on Power Electronics, pp. 5567-5575, May 2024, doi: 10.1109/TPEL.2024.3354833.
[2] J. Shu et al., “Stacked Strongly Coupled GaN/SiC Cascode Device with Fast Switching and Reclaimed Strong dv/dt Control,” 2024 IEEE International Electron Devices Meeting (IEDM), San Francisco, CA, USA, 2024, pp. 25.1.1-25.1.4, doi: 10.1109/IEDM50854.2024.10873458.
[3] Z. Zhang, B. Guo, F. F. Wang, E. A. Jones, L. M. Tolbert, and B. J. Blalock, “Methodology for Wide Band-Gap Device Dynamic Characterization,” IEEE Transactions on Power Electronics, vol. 32, no. 12, pp. 9307-9318, Dec. 2017, doi: 10.1109/TPEL.2017.2655491.
[4] J. Shu, J. Sun, Z. Zheng and K. J. Chen, “Gate Driver Design for SiC Power MOSFETs With a Low-Voltage GaN HEMT for Switching Loss Reduction and Gate Protection,” in IEEE Transactions on Power Electronics, vol. 39, no. 5, pp. 5558-5566, May 2024, doi: 10.1109/TPEL.2024.3353460.

What is claimed is:

1. A gate-driving circuit for controlling a cascode power device to switch on or off according to an external control signal via driving a gate of the cascode power device with a gate-driving voltage, the gate-driving circuit comprising:
a gate-driving signal generator configured to receive the external control signal and generate the gate-driving signal according to the external control signal as received, wherein the gate-driving signal generator is further configured to be entirely powered by a single power source; and
a local power supply acting as the single power source for powering the gate-driving signal generator, wherein the local power supply is further configured to be powered with raw electrical power received from an M point of the cascode power device such that the gate-driving circuit is self-powered without connecting to an external power supply to thereby avoid a need to install an isolation circuit to isolate a ground of the external power supply and an earth ground of the cascode power device for suppressing ground bounce.

2. The gate-driving circuit of claim 1, wherein the gate-driving signal generator comprises:
a gate driver for generating the gate-driving signal according to a first control signal, wherein the gate-driving signal and first control signal are referenced to a digital ground (DGND) of the gate driver; and
a digital isolator configured to receive the external control signal and generate the first control signal according to the external control signal such that the first control signal and external control signal are mutually electrically-isolated to achieve ground isolation.

3. The gate-driving circuit of claim 1, wherein the gate-driving signal generator comprises:
a gate driver configured to generate the gate-driving signal from the external control signal, wherein the gate-driving signal and external control signal are referenced to a digital ground (DGND) of the gate driver.

4. The gate-driving circuit of claim 1, wherein the gate-driving signal generator comprises:
a gate driver configured to generate the gate-driving signal from the external control signal, the gate-driving signal being referenced to a digital ground (DGND) of the gate driver, wherein the gate driver is further configured to receive and process the external control signal, the external control signal having a signal format of a differential input signal.

5. The gate-driving circuit of claim 1, wherein the local power supply comprises:
a bootstrap unit (BTU) configured to receive the raw electrical power from the M point of the cascode power device and to generate an unregulated supply voltage from the raw electrical power; and
a voltage regulator for generating a regulated supply voltage from the unregulated power supply voltage, the regulated supply voltage being used to power the gate-driving signal generator.

6. The gate-driving circuit of claim 5, wherein the voltage regulator is a low dropout (LDO) regulator.

7. The gate-driving circuit of claim 5, wherein the voltage regular is selected from a switch capacitor converter, a buck converter, a boost converter, a buck-boost converter, and combinations thereof.

8. The gate-driving circuit of claim 5, wherein the BTU includes:
one or more capacitors for storing electrical energy received from the M point of the cascode power device such that the electrical energy is releasable from the one or more capacitors to power the gate-driving signal generator; and
a diode for blocking the electrical energy stored in the one or more capacitors from flowing back to the M point of the cascode power device.

9. The gate-driving circuit of claim 8, wherein the diode is a Schottky barrier diode, a pn junction diode, or a lateral field-effect rectifier.

10. The gate-driving circuit of claim 2, wherein the gate driver is configured to generate the gate-driving signal that is adapted to drive a gate of a GaN/SiC cascode device.

11. The gate-driving circuit of claim 3, wherein the gate driver is configured to generate the gate-driving signal that is adapted to drive a gate of a GaN/SiC cascode device.

12. The gate-driving circuit of claim 4, wherein the gate driver is configured to generate the gate-driving signal that is adapted to drive a gate of a GaN/SiC cascode device.

13. The gate-driving circuit of claim 2, wherein the gate driver is configured to generate the gate-driving signal that is adapted to drive a gate of a Si/SiC cascode device.

14. The gate-driving circuit of claim 3, wherein the gate driver is configured to generate the gate-driving signal that is adapted to drive a gate of a Si/SiC cascode device.

15. The gate-driving circuit of claim 4, wherein the gate driver is configured to generate the gate-driving signal that is adapted to drive a gate of a Si/SiC cascode device.

16. The gate-driving circuit of claim 2, wherein the gate driver is configured to generate the gate-driving signal that is adapted to drive a gate of a Si/GaN cascode device.

17. The gate-driving circuit of claim 3, wherein the gate driver is configured to generate the gate-driving signal that is adapted to drive a gate of a Si/GaN cascode device.

18. The gate-driving circuit of claim 4, wherein the gate driver is configured to generate the gate-driving signal that is adapted to drive a gate of a Si/GaN cascode device.
